(19) United States
(12) Patent Application Publication
(10) Pub. No.: US 2019/0251476 A1
(43) Pub. Date: Aug. 15, 2019

(54) REDUCING REDUNDANCY AND MODEL DECAY WITH EMBEDDINGS

(71) Applicants: Daniel Shiebler, San Francisco, CA (US); Luca Belli, San Francisco, CA (US); Jay Baxter, San Francisco, CA (US); Hanchen Xiong, San Francisco, CA (US); Abhishek Tayal, San Francisco, CA (US)

(72) Inventors: Daniel Shiebler, San Francisco, CA (US); Luca Belli, San Francisco, CA (US); Jay Baxter, San Francisco, CA (US); Hanchen Xiong, San Francisco, CA (US); Abhishek Tayal, San Francisco, CA (US)

(21) Appl. No.: 16/271,630

(22) Filed: Feb. 8, 2019

Related U.S. Application Data
(60) Provisional application No. 62/628,780, filed on Feb. 9, 2018.

(51) Int. Cl. G06N 20/20; G06F 17/16

(52) U.S. Cl. CPC G06N 20/20; G06F 17/16

(57) ABSTRACT

Methods and systems for generating entity embeddings for use with one or more machine learning models are described. The system comprises at least one storage device configured to implement a feature registry for storing features associated with at least one entity and at least one computer processor. The at least one computer processor is programmed to generate at least one entity embedding for the at least one entity, perform a plurality of benchmarking tasks on the generated at least one entity embedding to generate benchmarking data, and publish the at least one entity embedding and the benchmarking data to the feature registry to enable the at least one entity embedding to be shared among a plurality of machine learning models.

### RELATED APPLICATIONS

This Application claims priority under 35 U.S.C. § 119(e) to U.S. Provisional Application Ser. No. 62/628,780, filed Feb. 9, 2018, entitled “FIGHTING REDUNDANCY AND MODEL DECAY WITH EMBEDDINGS,” the entirety of which is incorporated herein by reference.

### BACKGROUND

Some systems including models that employ machine learning techniques are configured to consume large amounts of data and to make predictions based on the data in near real-time (e.g., microseconds). When such systems operate on sparse data, training the models is difficult and techniques such as binning or feature hashing may be used to facilitate model training. Additionally, when the data consumed by the systems changes over time, machine learning performance suffers from “covariate shift.”

### SUMMARY

As organizations work to take advantage of the benefits of machine learning, it is important to stay aware of its significant costs. As data distributions shift, models require constant maintenance and monitoring. As scale increases, computationally intensive exact solutions must give way to potentially unpredictable approximations. To make matters worse, cross-team redundancy is rampant in machine learning. Perhaps because of its role as a nascent field that attracts people with a variety of backgrounds, there are few consistent guidelines and best practices for developing reusable machine learning systems. As a result, large organizations tend to contain multiple modeling teams that all perform similar tasks in slightly different yet disjoint ways. It is becoming increasingly important to decrease duplication of efforts by sharing utilities, resources, and models across teams and company verticals. Some embodiments described herein are directed to architectures, tools, and techniques to facilitate this collaboration by generating embeddings that can be shared across multiple teams and machine learning tasks.

Some embodiments are directed to a computer-implemented system for generating entity embeddings for use with one or more machine learning models. The system comprises at least one storage device configured to implement a feature registry for storing features associated with at least one entity; and at least one computer processor programmed to: generate at least one entity embedding for the at least one entity; perform a plurality of benchmarking tasks on the generated at least one entity embedding to generate benchmarking data; and publish the at least one entity embedding and the benchmarking data to the feature registry to enable the at least one entity embedding to be shared among a plurality of machine learning models.

Some embodiments are directed to a computer-implemented method for generating entity embeddings for use with one or more machine learning models, the method comprising: generating based, at least in part, on features associated with at least one entity stored in a feature registry, at least one entity embedding for the at least one entity; performing a plurality of benchmarking tasks on the generated at least one entity embedding to generate benchmarking data; and publishing the at least one entity embedding and the benchmarking data to the feature registry to enable the at least one entity embedding to be shared among a plurality of machine learning models.

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

### BRIEF DESCRIPTION OF THE DRAWINGS

Various non-limiting embodiments of the technology will be described with reference to the following figures. It should be appreciated that the figures are not necessarily drawn to scale.

FIG. 1 illustrates the effect of co-variate shift for different types of social media data;

FIGS. 2A-2D illustrate examples of how a similarity measure between respective sets of words in social media data shifts over time;

FIG. 3 illustrates an architecture for generating entity embeddings in accordance with some embodiments;

FIG. 4 illustrates a flowchart of a process for generating entity embeddings in accordance with some embodiments;

FIG. 5 illustrates a wide-and-deep (WAD) model architecture that accepts both conventional sparse features and pre-computed embeddings in accordance with some embodiments;

FIG. 6 illustrates a co-embedding network architecture for generating co-embeddings in accordance with some embodiments;

FIG. 7 illustrates results of testing a folding-in technique to remove noisy data in accordance with some embodiments;

FIG. 8 illustrates a lookalike folding-in process in accordance with some embodiments;

FIG. 9 illustrates a multi-dimensional entity embedding generation technique in accordance with some embodiments; and

FIG. 10 illustrates an block diagram of a computer on which some embodiments may be employed.

### DETAILED DESCRIPTION

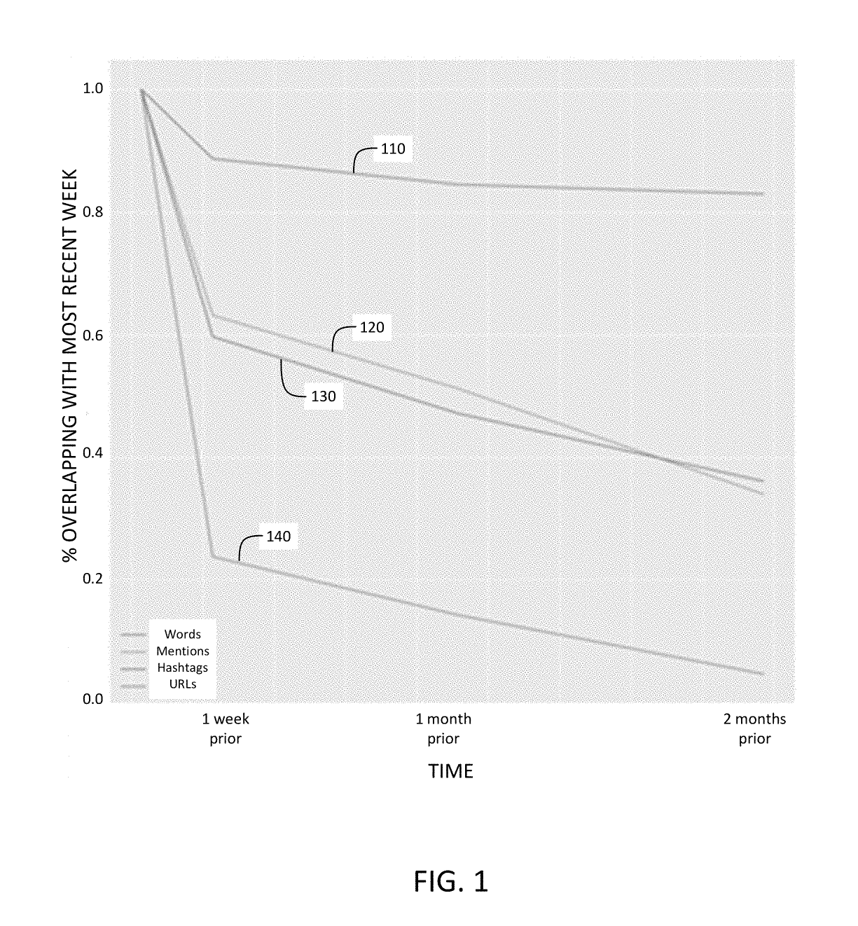

FIG. 1 demonstrates the effect of covariate shift for four different types of data in a social media ecosystem—words 110 (not including stopwords), mentions 120, hashtags 130, and linked websites (URLs) 140. The 5000 most popular mentions, URLs, hashtags, and words for a current week were compared with those that were most popular the previous week, one month prior, and one year prior. It can be observed that especially for mentions, linked websites, and hashtags, the frequency of overlap drops off quickly over time. For example, a model trained a month prior will have been trained with less than 50% of the current week's most popular hashtags.

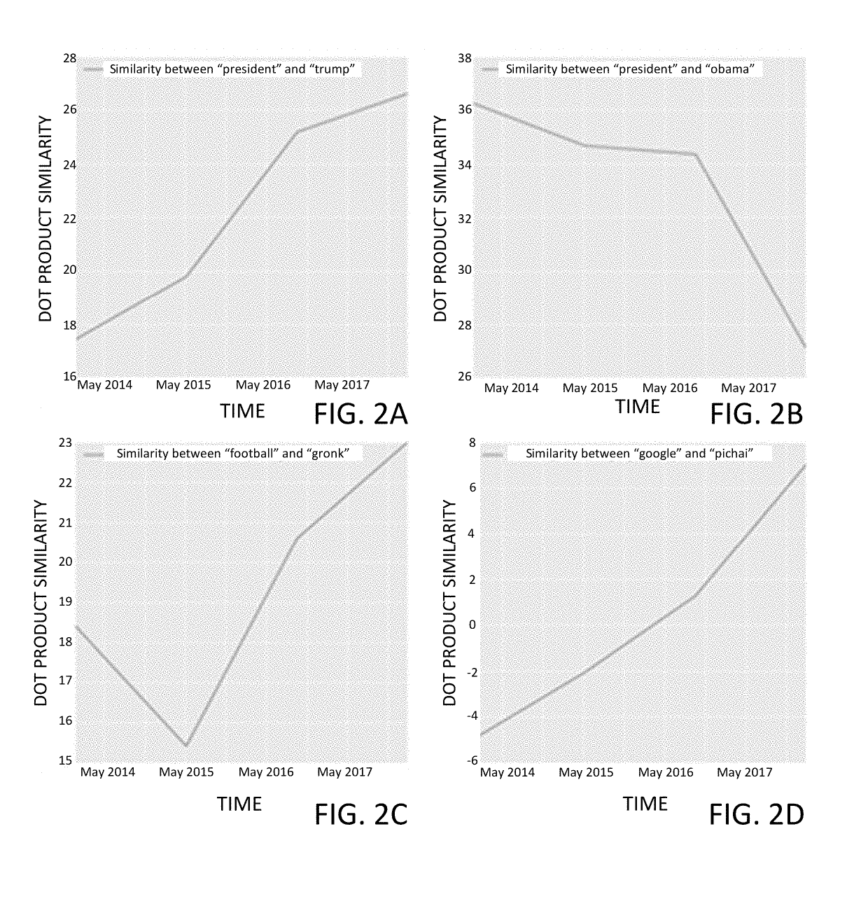

In addition to the coverage dropoff over time, the meanings of words may also change quickly. To see the effect of this kind of shift, consider a machine learning model that accepts text as inputs, where the text is represented as a series of word embeddings. This type of model tends to exploit the property that words that are close together in embedding space are also close in semantic meaning. However, as words shift in meaning, word vector models become stale and degrade the performance of all models that depend on them. To illustrate this effect, a series of skipgram word embedding models were trained using three years of data (e.g., Tweet data) and it was observed that certain word relationships changed dramatically over that time period, as shown in FIGS. 2A-2D. For example, as shown in FIG. 2A, the similarity between the word embedding models for the words “president” and “trump” was relatively low in 2014 and 2015, but increased substantially in 2016 and 2017. By contrast, as shown in FIG. 2B, the similarity between the word embedding models for the words “president” and “obama” was relatively high in 2014-2016, but reduced substantially in 2017 after President Obama exited office. FIG. 2C shows that the similarity between word embedding models for the words “football” and “gronk” fluctuated from 2014 to 2017, peaking in 2017 when the New England Patriots (on which Rob Gronkowski played) won the Super Bowl. FIG. 2D shows that the similarity between the word embedding models for the words “google” and “pichai” increased after Sunder Pichai was named the CEO of Google at the end of 2015.

The inventors have recognized and appreciated that when covariate shifts are not accounted for, machine learning models that consume rapidly changing data tend to perform poorly. For example, in the case of Twitter, if a public figure used a strange or misspelled word in a popular tweet, the presence of that word in other tweets is a strong indication that those tweets are related to that public figure. However, a stale word vector model (e.g., a model that does not take into consideration covariate shifts) would not capture this relationship. Some embodiments are directed to techniques for addressing these challenges using learned feature representations or embeddings of entities to be able to, for example, capture new word relationships that a stale word vector model would miss.

Embeddings are low dimensional dense representations of entities that can be utilized by one or more machine learning models. By reducing both the sparsity and the amount of data required to model each entity, embeddings can improve the performance of and reduce the computational load on machine learning models. In addition, since embeddings naturally represent the most relevant aspects of a data distribution, a regularly retrained embedding can reduce the impact of covariate shift.

Unlike hand crafted features, which are generated by rule based algorithms, learned embeddings are themselves outputs of machine learning models that require data to train and may be cumbersome to store and deploy. Like the models that they are used with, embeddings should be regularly retrained and benchmarked.

In order to address these issues and reap the benefits of embeddings, some embodiments are directed to a system architecture and tools that facilitate the customization, development, accessing and sharing of embeddings.

In some embodiments, each of a plurality of machine learning workflows are composed of a plurality of reusable programmatic components. The different programmable components can be different in nature. For example, several embedding pipelines may include libraries for both data collection and training. By defining a pipeline and scheduling it to regularly execute, it becomes possible to maintain fresh embedding models and guard against data distribution shift. Furthermore, since each pipeline is built from modular components, embedding generation pipelines may be adapted into larger systems.

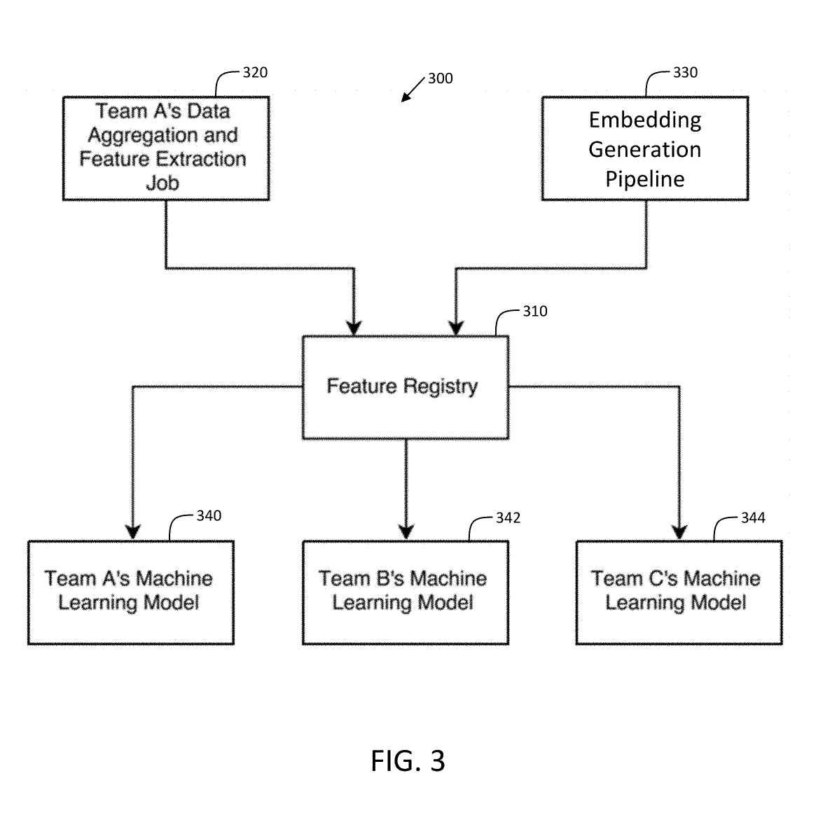

FIG. 3 illustrates an architecture 300 for managing embeddings in accordance with some embodiments. Architecture 300 includes feature registry 310. Feature registry 310 is the central feature management store that enables multiple teams employing different machine learning models to easily manage and share extracted features including entity embeddings. In some implementations, feature registry 310 provides a unified access layer configured to receive as input any kind of raw, derived or learned feature, thereby abstracting the complexity of feature generation and streamlining the model construction and deployment process. Feature registry 310 is configured to store features for each of a plurality of entities, examples of which include, user, tweets, and events. The features in feature registry 310 may be made available for easy access by any model that operates on that entity, examples of which are shown in architecture 300.

As shown, architecture 300 includes components that generate data to be stored in feature registry 310 and components that use the data stored in feature registry 310 to perform tasks that implement machine learning models. For example, architecture 300 includes data aggregation and feature extraction component 320 configured to collect recent data (e.g., Tweet data) extract features from the data, and subsequently store the features in feature registry 310. Architecture 300 also includes embedding generation pipeline 330 configured to generate entity embeddings, which are also subsequently stored in feature registry 310. Example implementations of the embedding generation pipeline are discussed in more detail below. Data, including entity embeddings, stored in feature registry 310 may be accessed by one or more machine learning models, examples of which include Team A's machine learning model 340, Team B's machine learning model 342, and Team C's machine learning model 344. The machine learning models 340, 342, and 344 may be associated with performing different tasks and may implement similar or different machine learning techniques and/or architectures for performing its corresponding task. Example tasks that may be performed using entity embeddings updated and stored in feature registry 310 are discussed in more detail below.

Unlike with a classification or regression model, it is difficult to measure the quality of an embedding. One of the reasons for this is that embeddings are used in different ways to perform different tasks. For example, while some user embeddings may be used in some instances as model inputs, in other instances, user embeddings may be used in nearest neighbor systems. To mitigate this problem, some embodiments include a plurality of standard benchmarking tasks for each type of embedding stored in the feature registry. These benchmarking tasks attempt to qualitatively measure the embedding independent of any of the models that make use of them. In some embodiments, every time an embedding is retrained it is automatically re-evaluated on one or more of the benchmarks, and the results are published in the feature registry along with the embeddings. Example benchmarking tasks include, but are not limited to:
User Topic Prediction During onboarding, users may indicate which topics interest them. The ROC-AUC of a logistic regression trained on user embeddings to predict those topics is a measure of that embedding's ability to represent user interests.
Metadata Prediction Certain users provide their demographic information (such as gender, age, etc.). The ROC-AUC of a logistic regression trained on user embeddings to predict this metadata is a measure of how well that embedding might perform on a downstream machine learning task.
User Follow Jaccard The similarity of two users' tastes can be estimated by the Jaccard index of the sets of accounts that the users follow. Over a set of user pairs, the rank order correlation between the users' embedding similarity (as determined with a similarity metric like Dot Similarity uv, Cosine Similarity

$$\frac{uv}{‖ u ‖ ‖ v ‖}$$

or Euclidian Similarity 1−|u−v|) and their follow sets. Jaccard index is a measure of how well the embedding groups users.

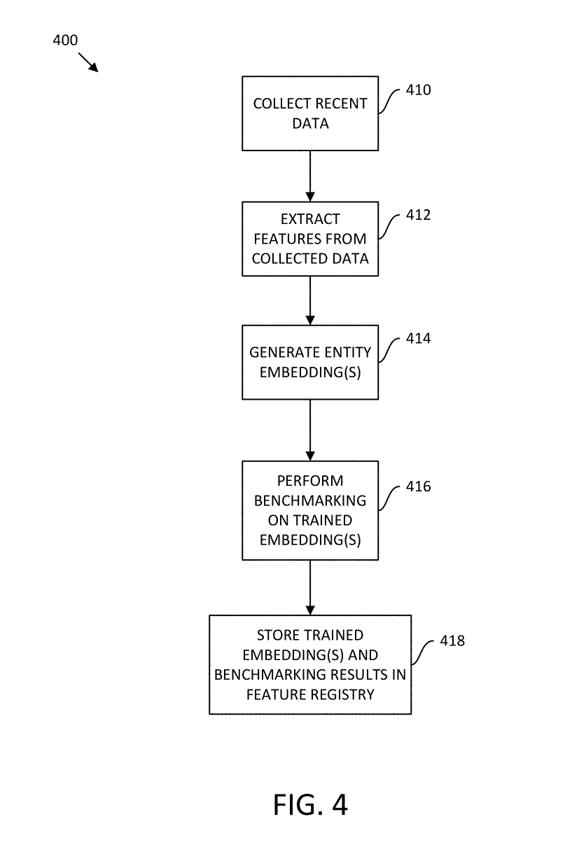

FIG. 4 illustrates a process 400 for creating benchmarked trained embeddings using the architecture 300, in accordance with some embodiments. In act 410, recent data for an entity is collected. For example, recent tweet data (e.g., from the past week) may be collected. Process 400 then proceeds to act 412, where one or more features are extracted from the collected data. For example, tweet data collected in act 410 may be analyzed to determine pairs of words that commonly co-occur in the data. Process 400 then proceeds to act 414, where one or more embeddings are generated for an entity (e.g., a user or a tweet). Illustrative techniques for generating entity embeddings are discussed in more detail below. Process 400 then proceeds to act 416, where one or more benchmarking tasks are executed to evaluate the quality of the trained embedding(s) generated in act 414. Process 400 then proceeds to act 418, where the trained embedding(s) and their corresponding benchmarking results are stored in the feature registry for use by one or more machine learning models, as illustrated in FIG. 3 and described briefly above.

In one example, a Word2Vec pipeline designed in accordance with some embodiments may include the following stages:
Execute a series of jobs to collect recent data (e.g., tweet data), concatenate the data into conversations, identify commonly used words and phrases, and form skipgram pairs.
Execute a co-occurrence pipeline, an example of which is described in more detail below, to generate word vector embeddings and publish them to the feature registry.
Execute a series of benchmarking tasks on the trained embeddings and post the results to the feature registry.

Described below are two example tasks on which using embeddings generated in accordance with the techniques described herein can improve performance of machine learning models. Also described are strategies used to incorporate embeddings into solutions for these tasks.

### Example Task: Email Recommendations

In an email recommendation task, the objective may be to identify data (e.g., tweets) that users might find to be the most interesting, and send the identified data (e.g., as a link in the email) to users in an email. The goal of these emails is to motivate users to open the email, and click on the identified data. An email recommendation is considered “successful” if a user clicks on the identified data. Therefore the email recommendation problem is: given a user and data (e.g., a tweet), determine whether the user would click on the identified data in an email.

Example task: New User Follow Recommendations

The very first experience users often have when creating a social media account is a New User Experience (NUX), where users are asked to upload an address book, select their interests, and then receive recommendations for social media accounts to follow. Since the accounts followed from this step compose a user's entire original timeline, there is a large potential for recommendations to make or break the initial social media experience. In addition, since this recommendation occurs immediately after a user signs up, many of the most important signals (such as social media data a user likes or the other accounts they follow) are absent. Therefore, the NUX follow recommendation problem is: given the information about a user that is present at signup time and a potential account to follow, predict whether the user will choose to follow this account.

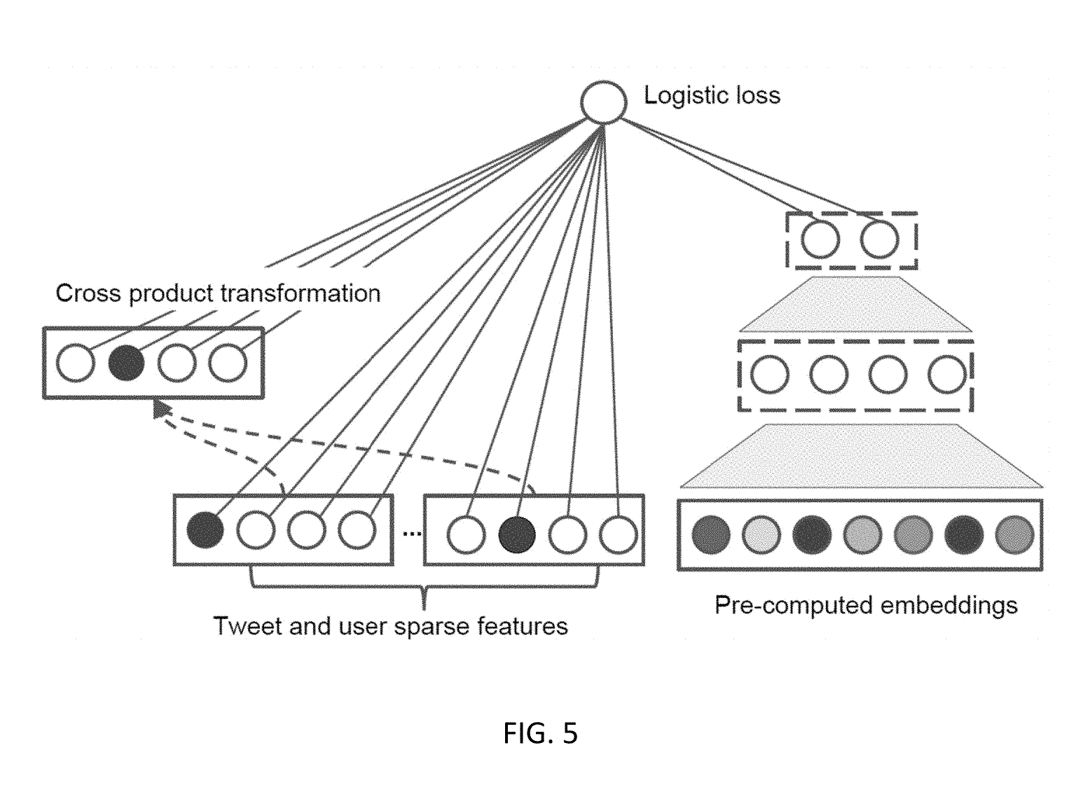

One solution to both the email recommendation and new user follow recommendation problems is to use a model like a multi-layer perceptron (MLP) that accepts user and data/account-to-follow features. When embeddings are not used, these features are typically limited to basic descriptive data and sparse features like tweet length, creator information, existing engagement statistics, user age, gender, location etc. Techniques like feature hashing, minimum description length (MDL) and the sparse cross-product transformation may be applied to improve performance of the models. In order to evaluate the degree to which embeddings can improve the performance of these models, versions of a wide-and-deep (WAD) model that accepts both conventional sparse features and pre-computed embeddings were created. The model architecture is illustrated in FIG. 5. Note that since the conventional sparse features are already very heavily engineered for their respective problems, providing additional improvements on top of these features with a generic embedding model is not a simple task.

### Embedding Strategies

An approach for representing users in terms of their interactions with items (e.g., tweets, other users) is the Low Rank Matrix Factorization paradigm. In this approach a sparse user-item affinity matrix is formed and approximated as the product of a low-rank user matrix and a low rank item matrix. Some advantages of using matrix factorization include the ability to simply interpret each dimension within the low-rank embeddings as an underlying “latent factor” and the ability to apply the technique to large datasets.

One example of using matrix factorization for generating embeddings in a social media context is for characterizing consumer-producer engagement. In this example, users are classified into one of two roles based on their behavior patterns: Producers and Consumers. Producers are users who have relatively large number of followers with attractive social media content, e.g., celebrities, activists, or politicians, while Consumers are all other users. By gathering and organizing engagement data (e.g., Likes, Retweets, Favorites) between Consumers and Producers, the sparse affinity matrix X can be formed where each entry xᵢⱼ represents the engagement strength of a Producer j to a Consumer i. To remove noise, reduce the matrix sparsity and improve efficiency, the graph may be pruned as follows:
(1) Identify all users who are not spammers or frictionless and whose user state is light plus (e.g., restrict to real users who are at least fairly active). This forms the prospective set of Consumers and Producers.
(2) Identify all follows from the user set in (1). These are the follows that determine Producers.
(3) Find N (=1 Million) users from (1) that have the most follows from (2). This is the set of Producers.
(4) For the users in (1), output their engagements, limiting to the Producers in (3).
(5) Perform normalization: normalize each element x_{i,j} in the matrix using the row sums and column sums:

$${x}_{i , j}^{norm} = \frac{{x}_{i , j}}{( \sqrt{{Σ}_{c ∈ cols} {x}_{i , c} * \sqrt{{Σ}_{r ∈ rows} {x}_{r , j}}}} .$$

The purpose of this normalization is to avoid giving outsized influence to the most popular accounts.

After the above construction and pruning steps, singular value decomposition (SVD) can be performed on the normalized matrix X:

X=UΣV^{T}

where Σ is the diagonal singular value matrix and the columns of U and V are the left and right singular vectors respectively. To obtain a low-rank factorization of X, the top-k singular values and associated left/right singular vectors may be used. Since the magnitude of singular value i reflects the significance of both the i^{th} left and the i^{th} right singular vectors, the square root of singular values may be absorbed into U and V to form the Consumers' and Producers' embedding matrices U* and V*:

X=(U\sqrt{Σ})(\sqrt{Σ}^{T}V^{T})=U*V*^{T}

The results shown in Table 1 below demonstrate that incorporating the user embeddings generated with the matrix factorization technique consistently improves the performance of the email recommendation model across all levels of user activity.

TABLE 1
ROC-AUC on the Email Recommendations task using a baseline
model versus using the wide-and-deep model to incorporate user
embeddings. It is observed that adding user embeddings creates
a consistent performance improvement.

| | | Base + 1000 | Baseline + 50 Element |
|---|---|---|---|
| | | element SVD | Autoencoded SVD |
| | Baseline | Embedding | Embedding |
| HeavyTweeter | 0.9252 | 0.9258 | 0.9258 |
| HeavyNonTweeter | 0.8741 | 0.8751 | 0.8751 |
| Light | 0.8458 | 0.8465 | 0.8464 |
| MediumNonTweeter | 0.9408 | 0.9413 | 0.9412 |
| MediumTweeter | 0.8696 | 0.8703 | 0.8704 |
| NearZero | 0.8941 | 0.8952 | 0.8950 |
| New | 0.7796 | 0.7845 | 0.7830 |
| NoUserState | 0.9292 | 0.9304 | 0.9319 |
| VeryLight | 0.8640 | 0.8649 | 0.8648 |
| Average | 0.9341 | 0.9345 | 0.9344 |

The results in Table 2 below demonstrate that incorporating Producer embeddings into the new user experience model can improve performance over using just a user embedding.

TABLE 2
Impact on new user experience model performance of the ALS TFW
Embedding both on its own and in combination with the Producer
SVD embedding

| Features | RCE | ROC-AUC |
|---|---|---|
| Baseline | 24.84 | 0.815 |
| Baseline + 100 Element ALS TFW Embedding | 27.56 | 0.835 |
| Baseline + 100 Element ALS TFW Embedding + | 27.88 | 0.836 |
| 1000 Element Producer SVD | | |

In order to quantify the performance of these Producer embeddings in a more direct manner, user embeddings were also computed with the DeepWalk algorithm and the results on three tasks were evaluated with human labeled data:

(1) LOS-Accounts: In this task, a logistic regression model on the top 10,000 producer embeddings was trained to classify them into one of 59 human-determined interest categories. The model's performance was evaluated as its classification accuracy.
(2) Known-For and Interested-In: In these tasks, for each of the top 100,000 producers a multi-output linear regression model was trained on that producer's embedding to predict the degree to which that producer is respectively “known for” and “interested in” each of 6011 tags (e.g. “news”, “hollywood”, “gastronomy”, “women in science”, etc.). The model's performance was measured as the average value of the normalized discounted cumulative gain (NDCG) between the model induced and human labeled rankings.

The results shown in Table 3 demonstrate that on all three tasks the SVD user embeddings outperform the DeepWalk embeddings.

TABLE 3
Evaluation of the SVD Producer embeddings versus a baseline follow
graph embedding on three human-labeled benchmark tasks.

| | LOS-Accounts | Known-Far | Interested-In |
|---|---|---|---|
| 1000 Element DeepWalk | 0.684 | 0.675 | 0.859 |
| 1000 Element SVD | 0.757 | 0.721 | 0.880 |

Another example of using matrix factorization to generate embeddings is for use with new user follow recommendations. Before most users sign up for a social media site such as Twitter they interact with components of the social media site in an indirect way by visiting web domains that have embedded social media content from that site (e.g., for Twitter this content is known as Twitter for Websites (TFW) domains). Similar to Consumer-Producer engagement embeddings, TFW embeddings can be learned by factorizing the user-TFW interaction matrix. Since this data is available during NUX, TFW domain embeddings are particularly useful for the NUX Follow Recommendation task.

An interesting facet of TFW data is that it's extremely lopsided: over 80% of users interact with the top five or so domains, but the distribution drops off quickly so that less than half a percent of users interact with the 100th most popular domain. Because the most popular TFW domains (e.g., www.google.com) tend to be mostly uninformative, they are removed. This leads to extreme sparsity, so an Alternating Least Squares (ALS) approach may be used to downweight the impact of zeros on the matrix factorization objective. In one implementation, the process proceeds as follows:
(1) Select the 1 million most popular TFW domains and the 5 million users who have the most interactions with these domains.
(2) Gather all of these users' visits to these domains to form the matrix A of user-TFW interactions. Normalize the matrix A (e.g., similarly to how the Consumer-Producer matrix above was normalized).
(3) Apply the Alternating Least Squares algorithm to factorize the normalized matrix A into the user and domain matrices U such that A≈UV, where the rows of U are the user embeddings.

As shown in Table 2, the ALS TFW domain embeddings provide a significant performance improvement for the NUX follow recommendation task.

In the social media context there are often separate teams working on different aspects of the social media platform that share a basic underlying problem of selecting a small subset of entities (e.g., Tweets, users, events, etc.) from a possible large set and presenting a ranked list of these entities to clients such that they deliver the desired customer experience. A few examples from the Twitter platform are:
(1) The home Timeline presents a ranked list of Tweets from a host of possible Tweets by first narrowing them down to Tweets engaged or authored by other users in your network or from out-of-network network authors based on your interests and past engagements.
(2) Email recommendations also presents a ranked list of Tweets to users, which can be a particularly challenging task for dormant/light users.
(3) An advertising workflow selects a small ranked list of line items that the customer is most likely to engage with from a possible large set, eligible to be displayed to the customer based on advertiser's chosen targeting criteria.
(4) When a new user signs up on Twitter, the onboarding workflow suggests a ranked, small list of existing users on the platform that the new user can follow from a possible huge number of existing users.

The inventors have recognized that although it may require a substantial amount of work for each team to develop their candidate recommendation systems in isolation, the use of embeddings for users and entities as described herein reduces the problem to an approximate nearest neighbor problem. For example, a similarity metric such as Dot Product uv, Cosine Similarity

$$\frac{uv}{‖ u ‖ ‖ v ‖}$$

or Euclidian Similarity 1−|u−v| is indicative of user-item affinity and may be used in a nearest neighbor paradigm to solve disparate problems. As such, some embodiments are directed to developing reliable user-item co-embeddings. The co-embeddings may be used within a nearest neighbor system for candidate recommendation or by using the co-embeddings directly in machine learning models.

The Consumer-Producer matrix factorization technique discussed above is an example of a co-embedding, where the Consumer and Producer embeddings are engineered such that the dot product of some Consumer's embedding and some Producer's embedding will be as close as possible to the number of engagements between that Consumer and that Producer. This framework works well when a fully collaborative co-embedding technique without user or item metadata is of interest and there is a concrete measure of “affinity” between a user and an item that the dot products should represent.

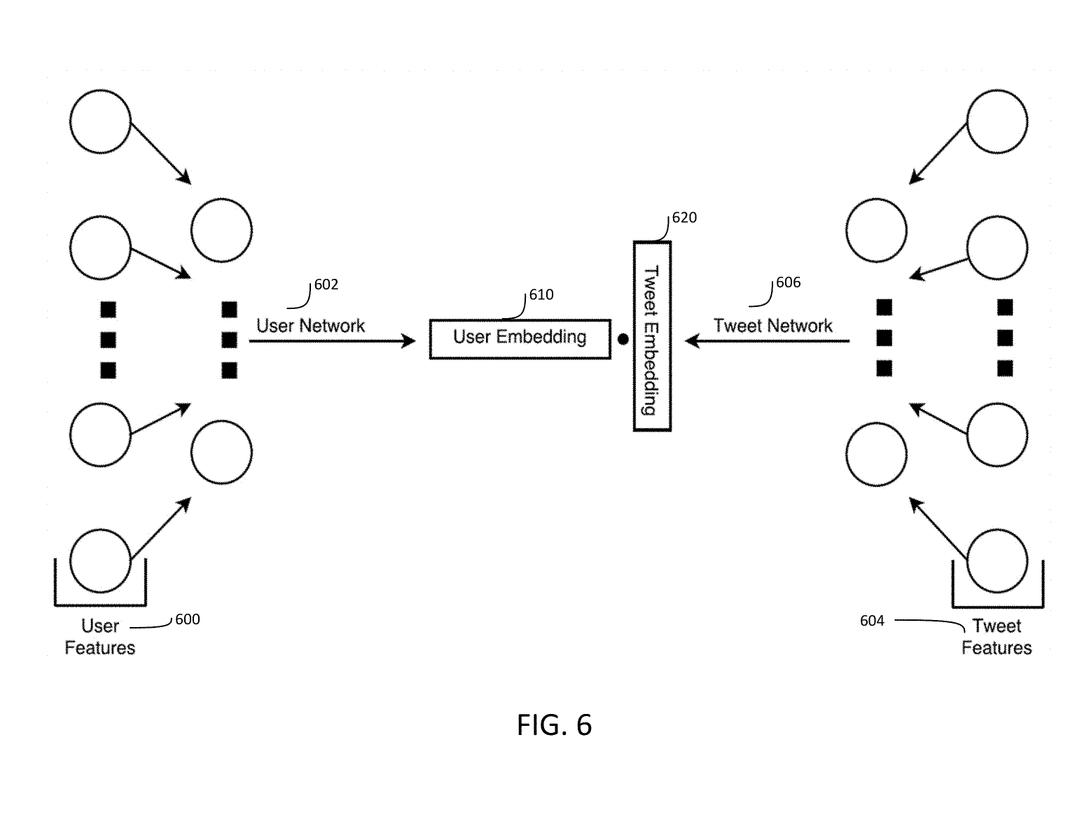

If the aim is to generate co-embeddings between users and items from arbitrary user and item features, an alternative approach may be used. For example, a generic co-embedding network system may be used to address this problem. FIG. 6 shows an example of such a network system that may be used in accordance with some embodiments. As shown, the system consists of two deep neural networks, a user network 602 and an item network 606. The user network 602 accepts a feature representation of a user (e.g., determined based on user features 600) and the item network accepts a feature representation of an item (e.g., determined based on item features 604), and both networks produce embeddings of the same length such that the dot product between the user embedding 610 and the item embedding 620 is indicative of the affinity between that user and item. To train the network, what is needed is a set of (user features, item features, affinity) tuples. Stochastic Gradient Descent may be used to directly maximize the consistency between the user-item embedding dot products and the affinity values. Since maintaining user or item embeddings in memory is not required, the scale of the system is only limited by the complexity of the user and item features. This approach works well to generate co-embeddings from complex nonlinear combinations of user and item features and when generation of real-time (or near real-time) embeddings for new users and items based on these features are desired.

In both of the above-described co-embedding techniques, the goal is to co-embed entities such that the dot product between two entities' embeddings is as close as possible to some measure of affinity between the entities. However, it is sometimes more convenient to frame the interaction between two entities in terms of “co-occurrences.” For example, a co-occurrence between a user and a Producer could be an instance of a user liking that Producer's content. Then the objective is to generate embeddings such that the dot product between two entities' co-embeddings is indicative of the entities' co-occurrence likelihood.

A “Co-Occurrence Embedding” system may be configured to generate co-embeddings for entity types e₁ and e₂ from a set of (e₁ᵢ, e₂ⱼ) co-occurrence pairs. The co-occurrence embedding pipeline may be integrated with a workflow automation and scheduling system to facilitate regular generation of new co-occurrence pairs and retraining of the embeddings. An example workflow is the Word2Vec embedding workflow described above. The co-occurrence embedding system may be configured to perform the following set of steps to pull the embeddings for entities that tend to co-occur closer together, and push embeddings for entities that rarely co-occur farther apart:
(1) Construct the embedding matrices E₁ and E₂, where the i^{th} row of E₁ (E₁ᵢ) and the j^{th} row of E₂ (E₂ⱼ) correspond to the embeddings for e₁ᵢ and e₂ⱼ respectively.
(2) For each (e₁ᵢ, e₂ⱼ) pair, select a group of “negative samples” See from the set of e₂ entities and perform an stochastic gradient descent step to minimize the loss function:

$$L = log σ ( {E}_{1} {E}_{{2}_{j}}^{T} ) + {\sum }^{j ∈ {S}_{{e}_{2}}} log σ ( - {E}_{1} {E}_{{2}_{j}}^{T} )$$

Examples of ways in which the co-embedding pipeline may be used to generate entity embeddings in accordance with some embodiments include:
(1) Co-embed two entity types based on a co-occurrence criteria between them, such as the Consumer-Producer example described above.
(2) Co-embed entity types e₁ and e₂ by representing e₁ as a “a bag of features”, defining a co-occurrence criteria between e₁'s features and e₂, and assigning e₁'s embeddings to be the weighted average of its feature embeddings.
(3) Embed a single entity type according to a co-occurrence criteria. For example, co-embeddings may be used to generate word embeddings based on the co-occurrence criteria that two words appear near each other in a document.

A comparison of some of the co-embedding generation techniques in accordance with some embodiments is shown in Table 4 below.

TABLE 4
Comparison of co-embedding techniques

| | | Co- | Co- | Co- |
|---|---|---|---|---|
| | Matrix | Embedding | Occurrence | Occurrence |
| | Factorization | Network | (Direct) | (Bag of Features) |
| Kind of | Collaborative | User/Item | Collaborative | Feature |
| Feature | | Metadata | | Collaborative |
| Nonlinear | No | Yes | No | No |
| Scalability | Medium | Very High | High | High |
| Data | User-Item | User-Item | Item-Item | Feature-Item |
| Objective | Affinity | Affinity | Co- | Co- |
| | | | Occurrence | Occurrence |
| Handles | Yes | Yes | No | Yes |
| New Users | (with | | | |
| | folding in) | | | |
| Handles | No | Yes | No | Yes |
| New Items | | | | |

The technique (2) is particularly robust in situations where the aim is to model new items in real-time or near real-time (e.g., microseconds), since new embeddings can be computed with just a table lookup and a vector average. For example, technique (2) may be used to co-embed users and Tweets by representing Tweets as “bags of words,” and defining the user-word co-occurrence criterion as “word appears in Tweet that user likes.” This strategy allows for quick computation of new tweet embeddings that can be directly matched with existing user embeddings to make recommendations.

The technique (2) can also be used to generate embeddings for new users based on their indirect (e.g., TFW domain) interactions. If a (TFW domain, Producer) co-occurrence event between domain r and Producer p is defined as a user who both visits r and follows p, the co-embedding can be used to generate embeddings for new users, and the new user embeddings can be matched with existing Producers to improve the performance of the NUX recommendation model. For example, it has been shown that adding the dot product between a new user's 300 element TFW domain embedding and the Producer's embedding to the feature set improves the RCE and ROC of the NUX model by 0.14 and 0.001 respectively.

A potential limitation of some of the embedding techniques discussed (such as Matrix Factorization and Direct Co-Occurrence) is that all of the entity embeddings are generated and saved at the same time. This makes it challenging to bring new entities into the system without retraining the model from scratch. Furthermore, if a particular model needs to be trained with all of the users and items for which generating embeddings is desired, it is not straightforward to remove noisy samples from the training set.

To give an example, consider the problem of generating Consumer and Producer user embeddings with a matrix factorization approach. The model uses the recent interactions between Consumers and Producers to quantify Consumers' affinities for Producers. For relatively mature and active users this is a good approximation. However, new and inactive users have significantly fewer interactions with Producers, so their Producer interactions are noisier approximations of their Producer affinities. Therefore, better overall performance of the model may be observed by omitting these noisy users from the model training.

Some embodiments are directed to techniques for addressing at least some of the limitations of the embedding strategies described above by using “folding in” strategies to assign static embeddings to new entities without affecting the original embedding model. To illustrate how this works, consider a matrix factorization model where the user-item interaction matrix X is approximated with the product of the low rank user matrix U and the low rank item matrix V. Then for some new user with interaction vector x, the objective is to assign to them the embedding u such that ∥uV−x∥ is minimized. If the matrix factorization model is a singular value decomposition (SVD) model, this is equivalent to the problem of projecting the vector x onto the user embedding vector space. Writing the SVD such that X=U*ΣV*^{T}=(U*Σ^{1/2})(Σ^{1/2}V*^{T})=UV, it is possible to project x onto the row space of U with u=xV⁻¹=xV*Σ^{1/2}^{^{−1}}. If the matrix factorization model is a more general least squares model, then the same orthonormality guarantees associated with a SVD are not present, which makes it more difficult to perform the projection. However, a least squares solution method can still be applied or an approximation of V⁻¹ can be used.

The folding-in procedure can be expressed as the product of a sparse user-item interaction vector and a dense “fold-in” matrix. Therefore, folding in a new user may be performed by querying the feature registry for the rows of the dense matrix corresponding to the items that user interacted with and computing their sum weighted by the strength of the user's interactions with those items. This is valuable for at least two reasons. First, the operation can be performed online without any modeling architecture, making it an attractive approach for assigning embeddings in low latency settings. Second, in an offline setting these operations can be expressed in a Map-Reduce framework, which allows for easily folding hundreds of millions of users into the matrix factorization models.

During the map phase, each item vector is converted to a set of (item, index, value) tuples and is joined to the set of (user, item, interaction) tuples to form a set of (user, index, value*interaction) tuples. During the reduce phase, the summing is performed along the user and index dimensions to produce the user embeddings. This structure allows the folding-in procedure to easily parallelize across multiple machines and quickly assign embeddings to hundreds of millions of users.

### Folding-in Experiment

In an experiment designed to test the folding-in procedure, a set of Twitter users and popular Twitter Producers were collected to form a sparse Consumer-Producer engagement matrix. It was explored how removing users with fewer engagements affected the performance of an Alternating Least Squares model.

Initially, the Consumer-Producer engagements were split into training and testing sets for each user. Then, the following steps were performed for different values of N:
(1) Select the top N percent of users and use their training set engagements to train the Alternating Least Squares model.
(2) Assign user embeddings to the remaining users by multiplying their training set engagements with an approximation of V⁻¹.
(3) Evaluate the model performance over the testing set engagements with the NDCG metric.

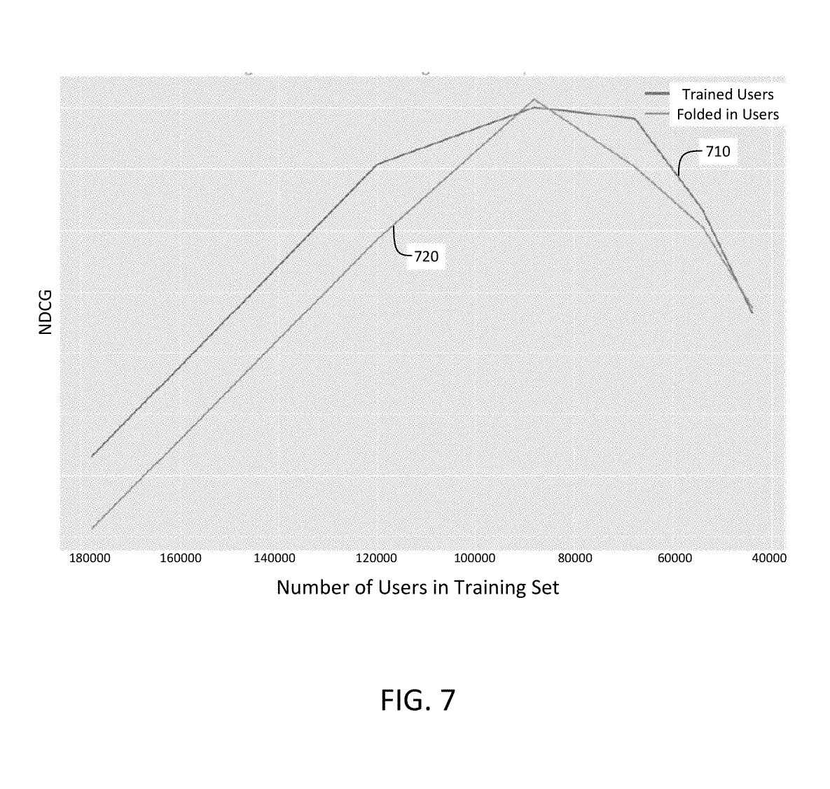

As shown in FIG. 7, the model's performance (measured by the NDCG metric) initially increased as noisier users were removed from the training set, but performance eventually peaked and began to decrease after the training set became too small. Importantly, this effect held over the trained users 710 on whom the model was fit and the users 720 folded into the model. That is, the prediction of noisy users' future engagements being more accurate when they were left out of the model fitting stage than when they were included was confirmed.

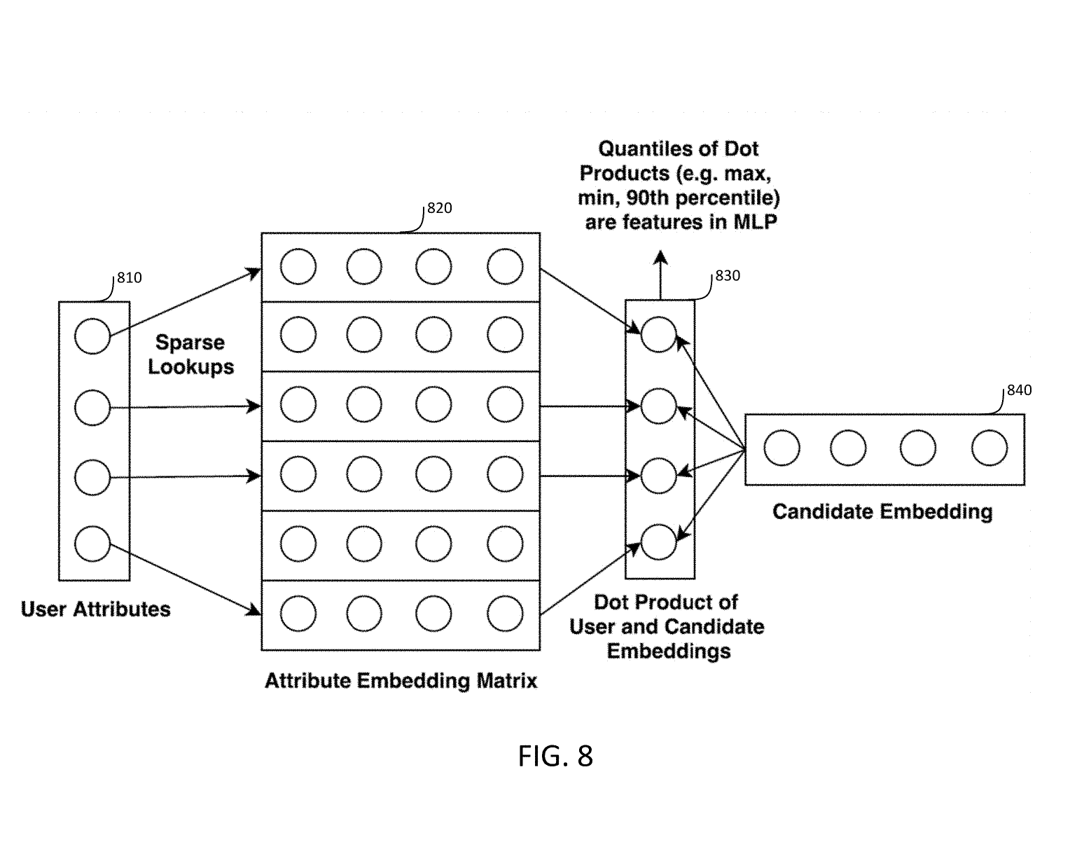

In some implementations, co-embeddings may be used to predict the affinity between a user with no interaction data and an entity. For example, the affinity between a new user and a Producer may be determined based on the Consumer-Producer SVD embedding. In these situations the folding-in strategies described above may need to be modified, as described below. This technique is referred to herein as “Lookalike” folding in, and is schematically illustrated in FIG. 8 as applied to new users.
(1) Look up user embeddings 820 for existing users that have user attributes 810 similar to the new user, e.g. users in the new user's address book, users who selected the same interest categories when they signed up, and users who are in the same geographical area.
(2) Compute the similarity 830 (e.g., dot product) of each user embedding 820 with the candidates' embeddings 840 and compute the quantiles (e.g. max/median/min) of these similarity vectors to generate a set of user features that can be used in a model.

It was found that incorporating the set of user features generated using the Lookalike folding technique into the NUX model improved the RCE and ROC by 0.47 and 0.004 respectively.

The inventors have recognized that in some instances the same entity embedding may be used in multiple different machine learning models. However, in other instances, it may be beneficial for different machine learning models to use embedding vectors of different lengths. For example, an analytics machine learning model that performs real-time interactive user segment analysis and requires low latency modeling, but is relatively robust to the lack of fine grained information about each user, may want to use a low dimensional user embedding vectors (e.g., embedding vectors with 20-50 elements). In contrast, for solving the email recommendation problem, offline latency may be less of a concern, but the standards for performance may be higher than for analytics. Therefore, email recommendation models may want to use higher dimensional user embedding vectors (e.g., embedding vectors with 100-1000 elements).

One approach to satisfy both of the above scenarios is to train separate embedding models for each type of machine learning model. However, such an approach decreases iteration speed and is difficult to scale. Some embodiments are directed to generating “democratized embeddings” that provide embeddings of different dimensionalities.

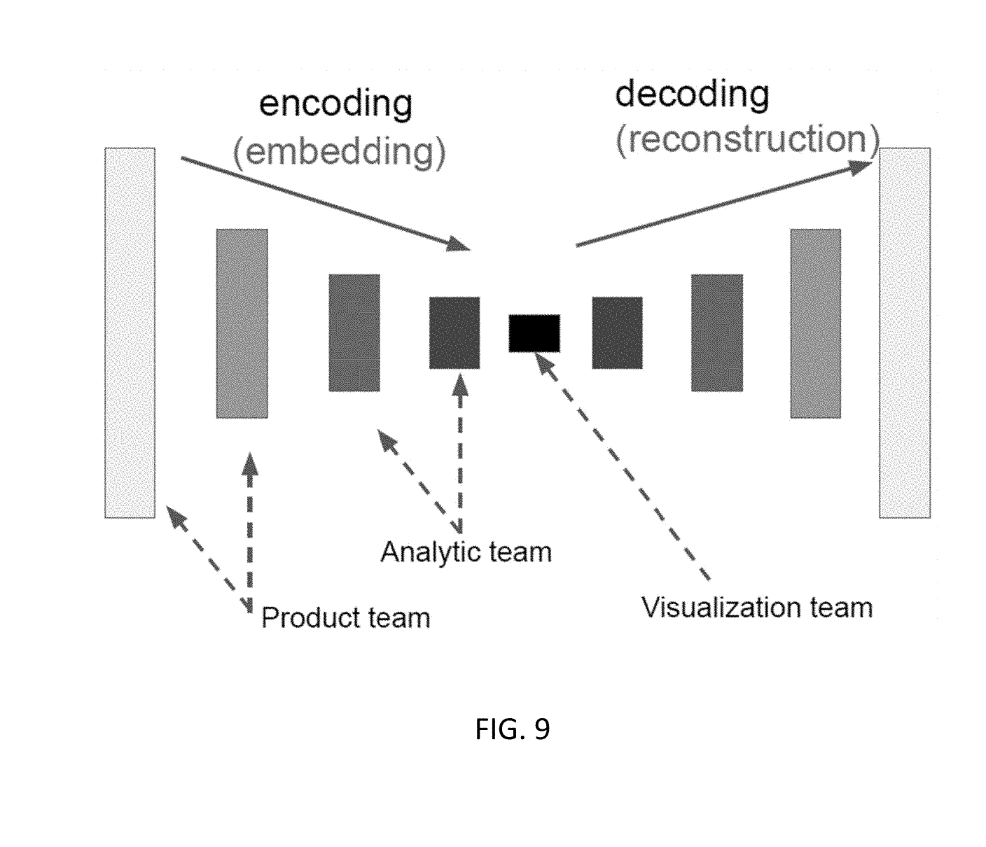

In some embodiments, a variation on the Deep AutoEncoder model is applied to generate multi-length embeddings. The Deep AutoEncoder is composed of two symmetrical deep-belief networks. One network performs an encoding operation f(·) while the other network performs a decoding operation g(·) as shown schematically in FIG. 9. The model accepts an original high-dimensional embedding as input, which it sequentially encodes into smaller and smaller embedding vectors, the final vector being decoded by the decoding network. The model is trained to minimize the difference between the original input embedding and the decoded output: arg min_{f,g}∥x−g(f(x))∥. In this construction, the number of neurons was monotonically decreased from the input layer to the bottleneck layer, and it was found that better performance was achieved by replacing the Restricted Boltzmann Machine's (RBM's) sigmoid activation function with the relu activation function.

Once the model is trained, each layer in the encoder serves as a user representation of different dimensionality. As illustrated in FIG. 9, each team (e.g., of a social media platform) can select the layer with the efficiency-quality tradeoff that best suits their particular task. As shown in Table 1, using this technique to nonlinearly reduce the size of Consumer-Producer SVDs from 1000 elements to 50 elements does not dramatically impact the performance of the Email Recommendation pipeline (whereas simply taking the top 50 elements of the SVD does dramatically reduce Email Recommendation performance).

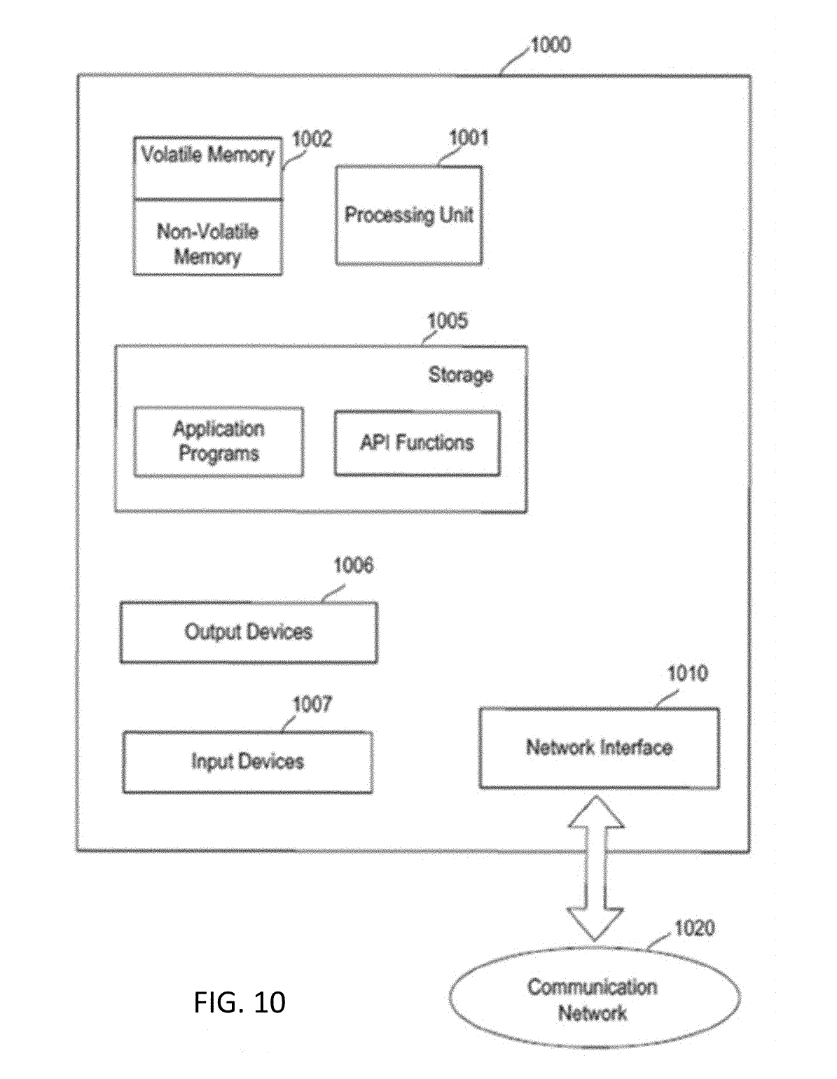

FIG. 10 shows, schematically, an illustrative computer 1000 on which any aspect of the present disclosure may be implemented. In the embodiment shown in FIG. 10, the computer 1000 includes a processing unit 1001 having one or more computer hardware processors and one or more articles of manufacture that comprise non-transitory computer-readable storage media (e.g., system memory 1002) that may include, for example, volatile and/or non-volatile memory. The computer-readable storage media 1002 may store one or more instructions to program the processing unit 1001 to perform any of the functions described herein. The computer 1000 may also include other types of non-transitory computer-readable media, such as storage 1005 (e.g., one or more disk drives) in addition to the system memory 1002. The storage 1005 may also store one or more application programs and/or external components used by application programs (e.g., software libraries), which may be loaded into the memory 1002. To perform any of the functionality described herein, processing unit 1001 may execute one or more processor-executable instructions stored in the one or more non-transitory computer-readable storage media (e.g., memory 1002, storage 1005), which may serve as non-transitory computer-readable storage media storing processor-executable instructions for execution by the processing unit 1001.

The computer 1000 may have one or more input devices and/or output devices, such as devices 1006 and 1007 illustrated in FIG. 10. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards and pointing devices, such as mice, touch pads, and digitizing tablets. As another example, the input devices 1007 may include a microphone for capturing audio signals, and the output devices 1006 may include a display screen for visually rendering, and/or a speaker for audibly rendering, recognized text.

As shown in FIG. 10, the computer 1000 may also comprise one or more network interfaces (e.g., the network interface 1010) to enable communication via various networks (e.g., the network 1020). Examples of networks include a local area network or a wide area network, such as an enterprise network or the Internet. Such networks may be based on any suitable technology and may operate according to any suitable protocol and may include wireless networks, wired networks or fiber optic networks.

Having thus described several aspects of at least one embodiment, it is to be appreciated that various alterations, modifications, and improvements will readily occur to those skilled in the art. Such alterations, modifications, and improvements are intended to be within the spirit and scope of the present disclosure. Accordingly, the foregoing description and drawings are by way of example only.

The above-described embodiments of the present disclosure can be implemented in any of numerous ways. For example, the embodiments may be implemented using hardware, software or a combination thereof. When implemented in software, the software code can be executed on any suitable processor or collection of processors, whether provided in a single computer or distributed among multiple computers.

Also, the various methods or processes outlined herein may be coded as software that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, the concepts disclosed herein may be embodied as a non-transitory computer-readable medium (or multiple computer-readable media) (e.g., a computer memory, one or more floppy discs, compact discs, optical discs, magnetic tapes, flash memories, circuit configurations in Field Programmable Gate Arrays or other semiconductor devices, or other non-transitory, tangible computer storage medium) encoded with one or more programs that, when executed on one or more computers or other processors, perform methods that implement the various embodiments of the present disclosure discussed above. The computer-readable medium or media can be transportable, such that the program or programs stored thereon can be loaded onto one or more different computers or other processors to implement various aspects of the present disclosure as discussed above.

The terms “program” or “software” are used herein to refer to any type of computer code or set of computer-executable instructions that can be employed to program a computer or other processor to implement various aspects of the present disclosure as discussed above. Additionally, it should be appreciated that according to one aspect of this embodiment, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically, the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that conveys relationship between the fields. However, any suitable mechanism may be used to establish a relationship between information in fields of a data structure, including through the use of pointers, tags or other mechanisms that establish relationship between data elements.

Various features and aspects of the present disclosure may be used alone, in any combination of two or more, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Also, the concepts disclosed herein may be embodied as a method, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Use of ordinal terms such as “first,” “second,” “third,” etc. in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

What is claimed is:

1. A computer-implemented system for generating entity embeddings for use with one or more machine learning models, the system comprising:
at least one storage device configured to implement a feature registry for storing features associated with at least one entity; and
at least one computer processor programmed to:
generate at least one entity embedding for the at least one entity;
perform a plurality of benchmarking tasks on the generated at least one entity embedding to generate benchmarking data; and
publish the at least one entity embedding and the benchmarking data to the feature registry to enable the at least one entity embedding to be shared among a plurality of machine learning models.

2. The computer-implemented system of claim 1, wherein the at least one computer processor is further programmed to provide the at least one entity embedding to a first machine learning model and a second machine learning model.

3. The computer-implemented system of claim 1, wherein the at least one computer processor is further programmed to:
collect data associated with the at least one entity;
extract features from the collected data; and
store the extracted features in the feature registry.

4. The computer-implemented system of claim 3, wherein the at least one computer processor is further programmed to retrain the at least one entity embedding based, at least in part, on the extracted features.

5. The computer-implemented system of claim 1, wherein generating the at least one entity embedding comprises performing matrix factorization.

6. The computer-implemented system of claim 5, wherein the at least one entity comprises a first entity and a second entity, and wherein generating the at least one entity embedding comprises:
generating an interaction matrix based on interaction data between the first entity and the second entity; and
performing matrix factorization on the interaction matrix.

7. The computer-implemented system of claim 6, wherein performing matrix factorization on the interaction matrix comprises performing singular value decomposition on the interaction matrix to generate a first entity embedding for the first entity and a second entity embedding for the second entity.

8. The computer-implemented system of claim 1, wherein the at least one computer processor is further programmed to:
generate co-embeddings between a first entity and a second entity.

9. The computer-implemented system of claim 8, wherein generating co-embeddings between a first entity and a second entity comprises:
providing a co-embedding network system that includes a first neural network configured to receive as input, features associated with the first entity and configured to output a first entity embedding and a second neural network configured to receive as input, features associated with the second entity and configured to output a second entity embedding;
determining a similarity measure between the first and second entity embeddings output from the first and second neural networks, respectively; and
training the co-embedding network based, at least in part, on a set of tuples each of which includes a first entity feature, second entity feature, and an affinity measure.

10. The computer-implemented system of claim 9, wherein training the co-embedding network further comprises for each tuple in the set, maximizing a consistency between the determined similarity measure and the affinity measure in the tuple.

11. The computer-implemented system of claim 9, wherein the similarity measure comprises a dot product of the first and second entity embeddings.

12. The computer-implemented system of claim 8, wherein generating co-embeddings between a first entity and a second entity comprises:
generating the co-embeddings from a set of co-occurrence pairs determined from the features stored in the feature registry.

13. The computer-implemented system of claim 8, wherein generating co-embeddings between a first entity and a second entity comprises:
defining co-occurrence criteria between each of the features of the first entity and the second entity to generate feature embeddings for the first entity;
generating the co-embeddings as a weighted average of the generated feature embeddings.

14. The computer-implemented system of claim 1, wherein the at least one computer processor is further programmed to:
perform a folding-in technique to generate an entity embedding for a new entity associated with sparse data.

15. The computer-implemented system of claim 1, wherein generating at least one entity embedding for the at least one entity comprises generating a plurality of entity embeddings for an entity, each of which has a different dimensionality.

16. A computer-implemented method for generating entity embeddings for use with one or more machine learning models, the method comprising:
generating based, at least in part, on features associated with at least one entity stored in a feature registry, at least one entity embedding for the at least one entity;
performing a plurality of benchmarking tasks on the generated at least one entity embedding to generate benchmarking data; and
publishing the at least one entity embedding and the benchmarking data to the feature registry to enable the at least one entity embedding to be shared among a plurality of machine learning models.

17. The computer-implemented method of claim 16, further comprising:
collecting data associated with the at least one entity;
extracting features from the collected data; and
retraining the at least one entity embedding based, at least in part, on the extracted features.

18. The computer-implemented method of claim 16, wherein the at least one entity comprises a first entity and a second entity, and wherein generating the at least one entity embedding comprises:
generating an interaction matrix based on interaction data between the first entity and the second entity; and
performing matrix factorization on the interaction matrix.

19. The computer-implemented method of claim 16, further comprising performing a folding-in technique to generate an entity embedding for a new entity associated with sparse data.

20. The computer-implemented method of claim 1, wherein generating at least one entity embedding for the at least one entity comprises generating a plurality of entity embeddings for an entity, each of which has a different dimensionality.
